(19) United States
(12) Patent Application Publication
(10) Pub. No.: US 2008/0264989 A1
(43) Pub. Date: Oct. 30, 2008

(54) Roof rack carrier system incorporating a rotary latch

(76) Inventors: Thomas John Barquinero, Bend, OR (US); William Paul Smith, Bend, OR (US)

Correspondence Address: Thomas M. Spear, Jr., P.O. Box 1274, Bend, OR, 97709-1274, US

(21) Appl. No.: 12/148,438

(22) Filed: Apr. 17, 2008

Related U.S. Application Data
(60) Provisional application No. 60/914,185, filed on Apr. 26, 2007.

(51) Int. Cl. B60R 9/058

(52) U.S. Cl. 224/315; 224/319

(57) ABSTRACT

The vehicular roof rack cargo carrier system of the preferred embodiment includes rotary latch housing units that can be affixed to roof rack crossbars (also referred to as load bars) plus cargo carrier vessels that have exterior-positioned built-in retention rods. The rotary latch—retention rod system enables carriers to be securely attached to and easily disengaged from roof racks when the carriers themselves are filled with content. The carriers then become portable enabling designs with features such as wheels and handles. Taken altogether, the system enables the creation of content-filled cargo carriers that have product functionality and consumer purpose away from point of vehicle. Applications include, but are not limited to, Luggage Carriers, Home & Garage Storage Carriers, Camping & Picnicking Carriers, Document Carriers, Tradesman Contractor Carriers and other purposeful carriers that serve distinct off-vehicle storage needs that can easily snap-in and snap-out of vehicular roof racks for transport.

### CROSS REFERENCE TO RELATED APPLICATION

| | |
|---|---|
| Appl. No.: 60/914,185 | Filed: Apr. 26, 2007 |
| Appl. No.: 60/821,114 | Filed: Aug. 01, 2006 |

### BACKGROUND OF THE INVENTION

This invention relates generally to the vehicular roof rack cargo carrier field and, more specifically, to a new and improved cargo carrier system that advances prior art with expanded carrier vessel product functionality, particularly for off-vehicle purposes, and with an easier method for users to attach and remove their carrier vessels from their vehicular roof racks.

Cargo Carriers for vehicular roof racks are well known. The industry is dominated by several companies, who make cargo carriers in a variety of medium-to-large sizes in ABS (Acrylonitrile Butadiene Styrene) plastic. Secondary competitors market similar cargo carriers in different sizes and shape with similar functions using ABS, fiberglass and other composite materials. The state of prior art across all of today's offerings involves how cargo carriers are mounted to vehicular roof racks, how they function once mounted and how consumers use them as a result.

Currently, cargo carriers are mounted to vehicular roof racks in one of two ways. The most prominent (and oldest) method is nut and U-bolt mounting that requires the use of tools for installation. Consumers who mount their carriers in this manner tend to leave them on their roof racks on a permanent basis, although the same mounting tools can be used for un-bolting and removal if/when desired. Many versions of this more permanent method of mounting also incorporate a key-locking shroud over the nut & u-bolt component to inhibit theft.

The second (and newer) approach involves mounting from within the interior floor of an empty cargo carrier which can be subsequently closed and locked. This method utilizes a claw shaped mechanism—the bottom half underneath the carrier that clamps onto a roof rack crossbar and the upper half inside the bottom interior of the carrier which, like a clamp on a ski boot, can be clamped down to firmly tighten the bolt (and hence carrier) to the crossbar. This approach requires the cargo box to be empty in order to install it on a vehicular roof rack. As a result of prior art mounting methods, today's vehicular cargo carriers are always mounted as empty shells. Once mounted and then opened, independent free-standing cargo gets stored and removed from the carrier always at point of vehicle.

Generally, most cargo carriers do not have handles or wheels to assist in handling the carriers when the carriers are separated from the vehicles thereby limiting the functionality of the cargo carriers away from the roof rack. When cargo carriers are removed from the vehicle for any extended period of time, they are stored as empty shells as well. As a result, consumers use roof rack-based cargo carriers as they use their automotive interior trunks—as a space to store goods, gear, luggage and other cargo for vehicular transport. The most ubiquitous unit sold is a streamlined rectangular container popular for its capability to carry skis, golf clubs and other large items typically difficult or impossible to store in trunks.

Previous descriptions embody the near universal marketplace offerings today as made by the dominant companies selling cargo carriers. The previously described means for attaching, using and deploying cargo carriers have several identifiable limitations, including: the means for attaching and removing the cargo carriers; the limitations on the use of the cargo carriers when detached from the vehicle; and the limitations for securing the contents of the cargo carrier. The present invention provides an effective means for attaching and detaching the cargo carrier to a vehicle's roof rack; a purpose for the cargo carrier when removed from the vehicle; and a more effective means for securing the contents of the cargo carrier.

### BRIEF DESCRIPTION OF THE INVENTION

The key elements of our inventive attachment mechanism are rotary latches and retention rods. The method or system of attachment involves use of a rotary latch that is built into a housing unit called a Crossbar Cradle Clamp. This housing unit then attaches to all types of roof rack crossbars or side rails (which are typically of round pole, rectangular or diamond/sword shape). This rotary latch housing unit is then in position to engage a retention rod that is attached to or built into the exterior surface of a carrier vessel. This method of attachment is an innovation in the vehicular roof rack—cargo carrier market. It is an attachment system that provides its users with greater convenience and product functionality than is currently available with all prior art attachment methods.

It is important to note that rotary latches and retention rods are universally common hardware items that manufacturers deploy in innumerable product applications across industry categories. As a result, rotary latches come in a wide variety of shapes and styles. Since there are so many different types of rotary latches, they are typically categorized by subgroups. The more prominent subgroups are called slam latches, compression latches, cam latches and paddle latches. There also are a variety of ways to activate a rotary latch such as wireless release, electronic-controlled release and pneumatically-actuated release. Despite their subgroup differences, however, all rotary latches perform the same essential action of lock catching and free releasing of retention rods and are individually chosen based on their best fit in a product application—that is, the type of latch that would give the product user the easiest or desired performance latching solution. With respect to our specific inventive matter, the size, shape and nature of the vessel to be attached to the vehicle as well as the price/value range of consumer ease-of-use latching actions make all types of rotary latch solutions viable as vehicular roof rack—accessory vessel attachment mechanisms. The preferred embodiments in this patent application exhibit some of this viable variety.

It is also worth noting that rotary latches have a rich automotive history. For instance, rotary latches are ubiquitously used as a component of vehicle door latching mechanisms. Further, exterior trunk lids universally utilize a vertically-oriented rotary latch application, these days with mechanical or electronic release functionality deployed from the driver's seat environment. Hence, we see our invention as expanding on this deep rotary latch automotive history. The significant and non-obvious distinction, however, is that our invention will apply rotary latches to vehicular roof racks for the very first time as a new and better way to attach cargo and other accessory carrier vessels.

Further, we see our invention as an attachment mechanism that does not necessarily have to be a free-standing element. As already mentioned, the rotary latch element can be designed into an independent housing unit that can attach to roof rack crossbars or side rails, but it could also be incorporated into a roof rack crossbar or side rail, be built into the vehicular roof itself or even be attached to the exterior of the carrier vessel itself (making the crossbar, for example, the retention rod element). In any event, it is the rotary latch/retention rod connective matter that is at the unique heart of our invention and we seek patent protection of its variable deployment.

Lastly, a few comments on the retention rod element of the attachment mechanism are in order. In common practice, the retention rod can be any element that engages the rotary latch in open and closing position. A retention rod typically consists of a metal cylinder or hoop whose diameter fits the rotary latch fork opening. As previously mentioned, our inventive attachment mechanism requires that an appropriately-sized cylindrical retention rod be built into or otherwise affixed to the exterior of a carrier vessel in the best transport location to engage the rotary latch housing unit attached to a roof rack crossbar or side rail. There are two ways to accomplish this. The first is to design the retention rod into permanent position during the manufacture of an original carrier vessel. The other manner is to introduce a “retrofit kit”—a stand-alone retention rod and mounting plate that can be added to or attached on any existing carrier vessel. With the purchase of a retrofit retention rod kit that can be affixed to any carrier and a rotary latch housing unit that can fit any roof rack crossbar, our attachment mechanism method has retrofit applicability to all cargo carrier solutions available in the marketplace today.

In background summary, we see our unique cargo carrier system as creating a range of new opportunities in cargo carrier product functionality and thus the benefits they provide consumers in both on-vehicle and off-vehicle environments. Further, our rotary latch crossbar housing units offer a range of on-off activation methods including wireless key fob action which is by far the most convenient consumer use method ever invented. Hence consumers will have the choice of inexpensive manual rotary latch actuation through luxury higher-end actuation options. In addition, all our rotary latch housing units can be deployed on roof rack crossbars, load bars or side rails of all shapes and sizes without the typical roof rack installation warning restrictions found on conventional attachment methods. As for the carriers themselves, with retention rods built into or otherwise affixed to the exterior surface of cargo carrier vessels, an unlimited range of specialty cargo carriers become available to the marketplace for the first time. These include suitcase carriers, toolbox carriers, document carriers, general home & garage storage container carriers, ice cooler carriers and others that serve consumers off-vehicle storage product needs. The cargo carrier no longer needs to be simply an empty shell vessel for the storage of independently-stored gear or other items. Taken all together, our new cargo carrier system expands the possibilities of what can be transported atop the vehicular roof rack.

### BRIEF DESCRIPTION OF SEVERAL VIEWS OF THE DRAWINGS

FIG. 1 is a line drawing that shows the general operational view of a rotary latch clamping assembly, release knob mechanism with linkage and an open rotary latch fork where the retention rod of a cargo vessel is captured.

FIG. 2 provides an overall view of shell halves and assembly details.

FIG. 3 gives detailed internal mounting features required to install prior art release knob mechanism and rotary latch utilized inside of housings 12 and 14.

FIG. 4 details a typical 3-point retention rod layout used with the cross bar cradle clamping system.

FIG. 5 portrays a multi-slot crossbar cradle clamp application attached to crossbars on vehicular roof rack system.

FIG. 6 shows right shell half of static crossbar cradle clamp, through hole for assembly and stud plate hole.

FIG. 7 reveals inner slot guide, assembly pins, assembly boss, stud plate slot and spring recess.

FIG. 8 depicts an assembled rotary latch crossbar cradle clamp assembled to base with clamp bar assembly details.

FIG. 9 illustrates assembled static crossbar cradle clamp shell halves and assembly details with spring loaded clamping block in place.

FIG. 10 depicts an assembled rear static crossbar cradle clamp assembled to base with clamp bar in place but without crossbar installed.

FIG. 11 portrays multiple retention rod location details on bottom of luggage carrier.

FIG. 12 depicts a loaded luggage carrier as it would appear installed on original equipment manufacturer roof rack crossbars ready for transport and being held in place by single channel crossbar cradle clamps.

### DETAILED DESCRIPTION OF THE INVENTION

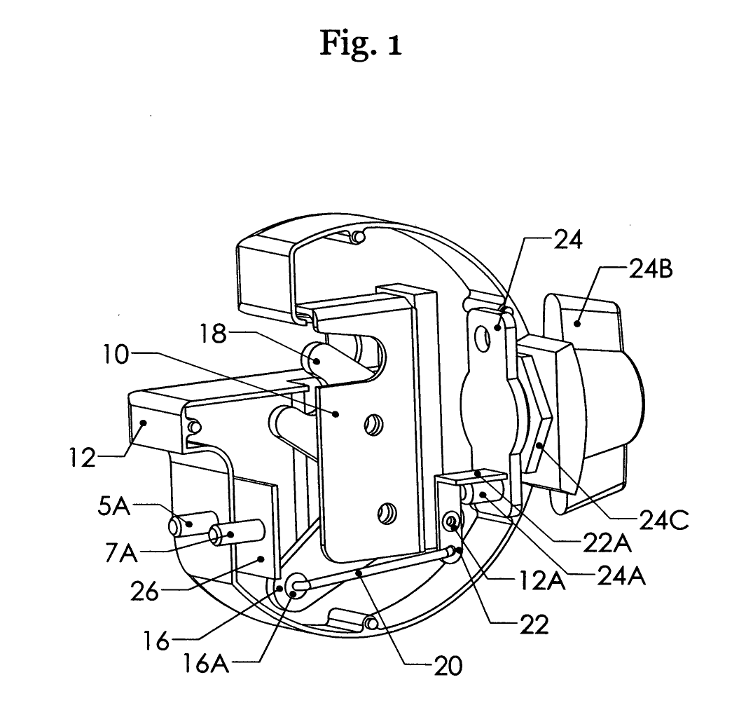

Referring to FIGS. 1, 2 and 3, rotary latch 10, is positioned and housed inside matching shell housings 12 and 14 with said rotary latch held in position by installation of two machine screws that pass through holes 3 and 4 found in shell half 12, into machine threads that exist on the side of prior art rotary latch 10, the body of the latch mechanism; which is well known prior art sometimes referred to commercially as a slam latch.

FIG. 1 depicts said rotary latch in an operationally open position. Rotary latch 10 typically utilizes one or more spring loaded cocking detents that progressively combine in action to restrict rotational movement of latch fork 18 once said fork is rotated into a vertically latched condition. From said latched condition release lever 16 is used to trigger the approximately 30 degree rotation of spring loaded latch fork 18 to the open position. In the preferred embodiment, said shell housings are formed using an ABS type plastic, however shell housings can consist of any other formable material that can be molded with sufficient strength to withstand operational stresses that occur from repeated loading and unloading of heavy cargo vessel attachments by the user. Rotary latch 10 is utilized in this horizontal loading orientation of the invention by using latch fork 18 to restrain forward, vertical and rearward movement of a rotary latch diametrical matching steel ⅜″ diameter retention rod that is embedded or otherwise attached to cargo vessel external surface geometries. Vertical orientation of said clamping latch may also be used to capture and retain larger cargo vessels to vehicular roof rack systems providing convenient quick loading and release of said cargo vessels and rooftop carriers. Other diameters or shapes of retention rod and matching latches may be used as long as said latches and matching retention loops or rods are of sufficient strength and configuration to operate properly.

Said rotary latch release lever 16 triggers spring loaded rotational movement of latch fork 18 to the open position when said release lever moves approximately one-eighth inch in a direction parallel with the rotational movement of said latch fork. Item 16 is moved via release rod 20 to initiate rotary latch 10's release back to an open condition once latch fork 18 has been cocked into the closed position by intrusion of said retention rod. Item 20's preferred embodiment is comprised of mold formed plastic shafting of sufficient strength and rigidity to provide a reliable service life. Said release rod has ends which are in 90 degree opposition to the common rod axis such that it transfers movement between release lever 16 and release bell crank 22. Said release rod features enlarged bulb ends that allow diametrical collapsing during insertion into release lever hole 16a found in 16, and release rod hole in release bell crank 22 while said bulb ends after passing through said holes revert to an uncompressed condition to provide a retention action keeping both ends of release rod 20 retained in said holes once said rod ends are snapped into said holes.

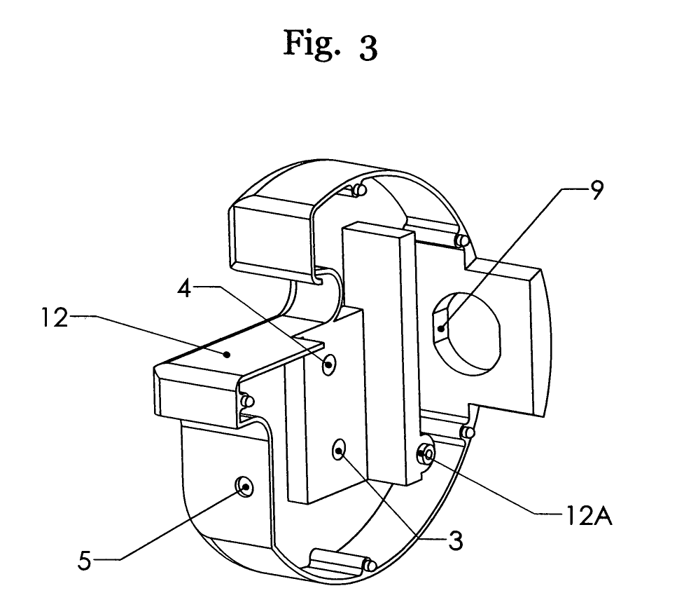

Release bellcrank 22 pivots on projected boss 12a to transfer the rotational motion plane of release knob plate 24 and corresponding actuation pin 24a to a linear motion plane parallel with release lever 16. Release bellcrank 22 pivots on projected boss 12a (FIG. 3) with said release bellcrank held in place on the diametrical surface of the boss with one self-threading screw and washer large enough to retain 22 on said boss without frictionally restricting rotational movement of said bellcrank on 12a. Bellcrank 22 pulls release rod 20 via transferred rotary movement exerted on pressure plate 22a by actuation dowel pin 24a as release knob 24b and interconnected said release knob plate is rotated by the user.

Referring to FIG. 1, release knob 24b features a key lock tumbler capable of restricting rotational movement of said release knob when locked by the user. Said release knob assembly is well known prior art commonly used in slam/rotary latch type commercial applications. Actuation dowel pin 24a is a short steel dowel pin permanently affixed in position via interference fit, swaging, knurl, weld or any other method facilitating permanent fastening of said steel dowel pin inside existing hole in said steel release knob plate 24.

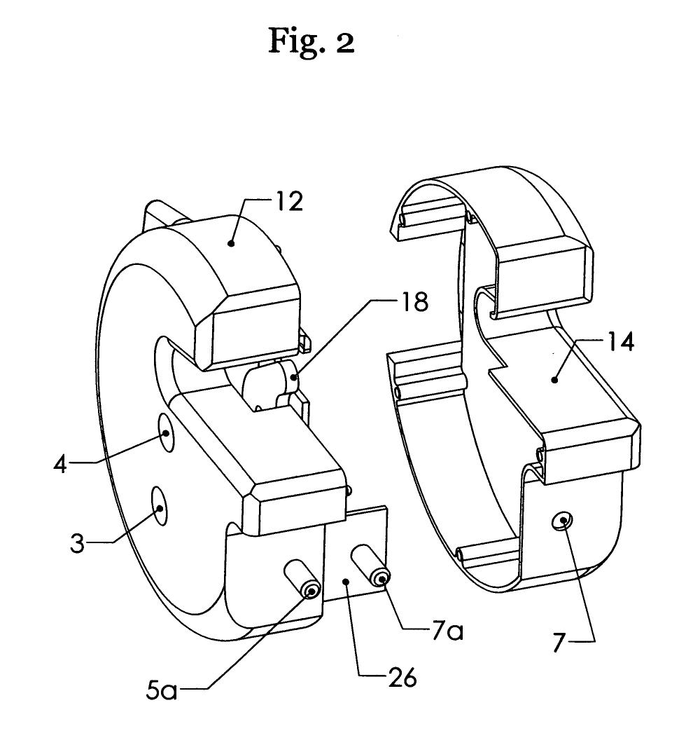

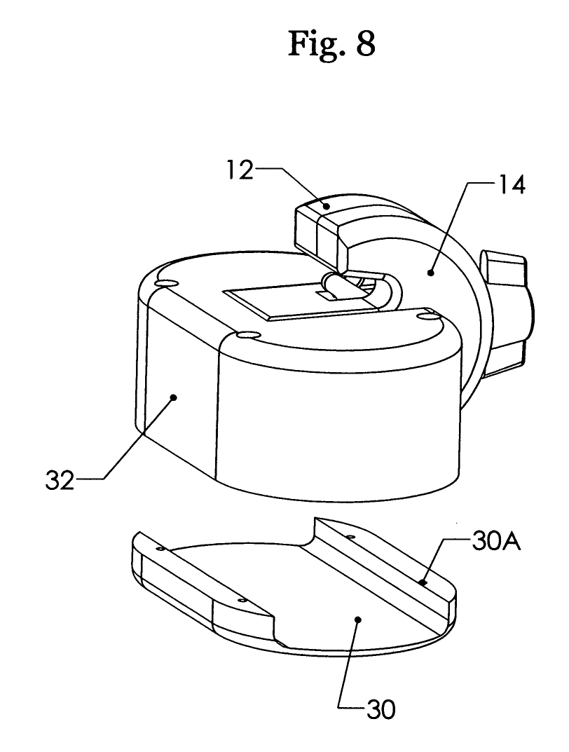

Shell housing 12, features small projecting alignment pins positioned around the outside periphery of said shell housing that engage with corresponding holes in shell housing 14, to ensure correct alignment of the said housings when placed together, as commonly practiced in prior art plastic injection molded joints. Prior to said shell housing joining process, stud 5a on clamping stud plate 26 is inserted into hole 5 (FIG. 3) inside of shell half 12 and as shell half 14 is aligned with 12 stud 7a is pulled through hole 7 (FIG. 2) in shell half 14 until said clamping stud plate is drawn flush with inner wall of said shell housings. Threaded studs 5a and 7a are used to align and permanently attach said shell housings to base 32 via internal matching clearance holes (FIG. 8) using nuts and washers matching thread requirements of said threaded studs.

Preceding the joining of shell housing 12 and 14 rotary latch 10 is permanently mounted to 12 using existing metal threads in rotary latch and truss head machine screws which pass through 3′ and 4′ holes shown in FIG. 2, with said screw heads attaining a flush condition relative to the outer surface of 12 via counterbored holes. Flat sided mounting cylinder body of release knob 24b is inserted through hole 9, (FIG. 3) in shell half 12 that incorporates two flattened sides conforming to release knob 24b mounting requirements to restrict rotation of said cylinder body knob assembly when said release knob is rotated. Said release knob cylinder body is retained in said flat sided hole via threaded cylinder body nut 24c supplied with said prior art locking knob assembly.

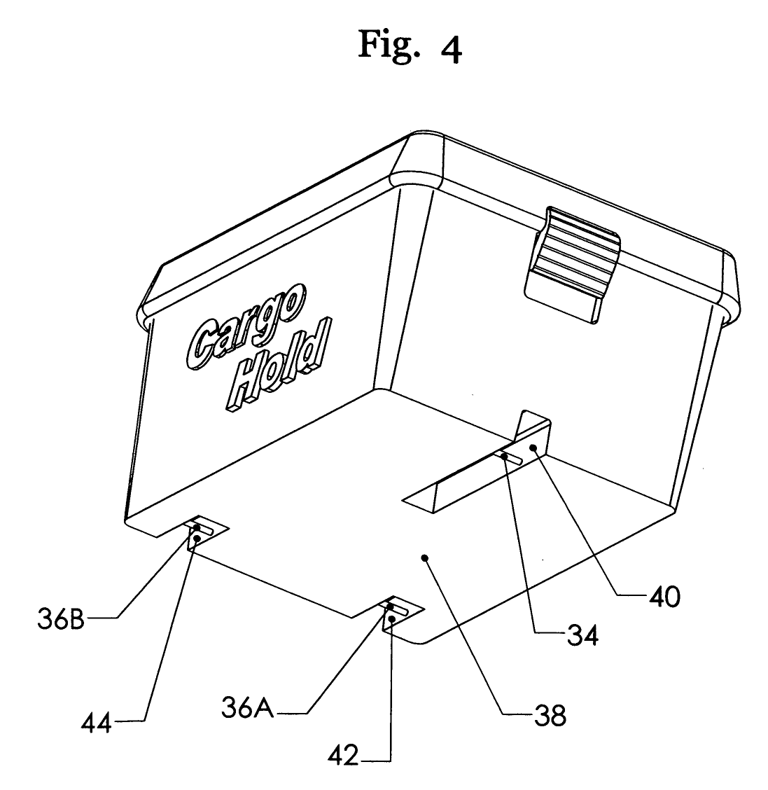

Referring to FIG. 4, and FIG. 8, top surface of base 32, serves as a landing platform for cargo vessel bottom surface 38, (FIG. 4) with said surface interface establishing the engagement height of embedded front retention rod 34 such that said rod will engage with and rotate latch fork 18 to the closed and locked position as retention rod 34 is pushed into rotary latch 10 by the user. Simultaneously occurring with cargo vessel movement toward locked travel position, vessel bottom channel 40 is guided by projecting shell halves 12 and 14 which combine to form a width suitable to center said rotary latch into said channel opening.

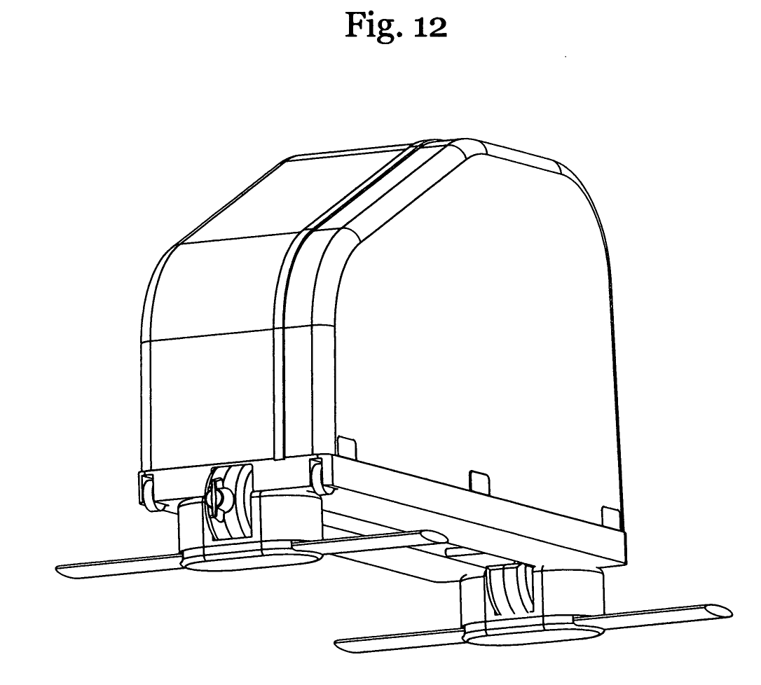

Clamp bar 30, (FIG. 8) is one of several clamping bar configurations that can be used to sandwich vehicular crossbars between clamp bar 30 and base 32 thereby attaching the entire clamping invention assembly on the vehicle for use. Base 32 containing assembled shell halves in this horizontal configuration accepts four stainless truss head self-tapping screws that install flush with top surface of said base via through hole and counterbore, with said screw thread engagement into clamping bar via corresponding holes typified by hole 30a. As shown in FIG. 12, a typical original equipment manufacturer flat crossbar can be accommodated via matching width clamp bar channel. Other clamp bars incorporating round, square and diamond crossbar shapes may be attached to base 32, corresponding to other aftermarket roof rack crossbar shapes via molded inserts or individually shaped clamp bars. In the preferred embodiment, said base and said clamp bar are formed using an ABS type plastic, however any other formable material that can be molded with sufficient strength to withstand operational stresses can be used.

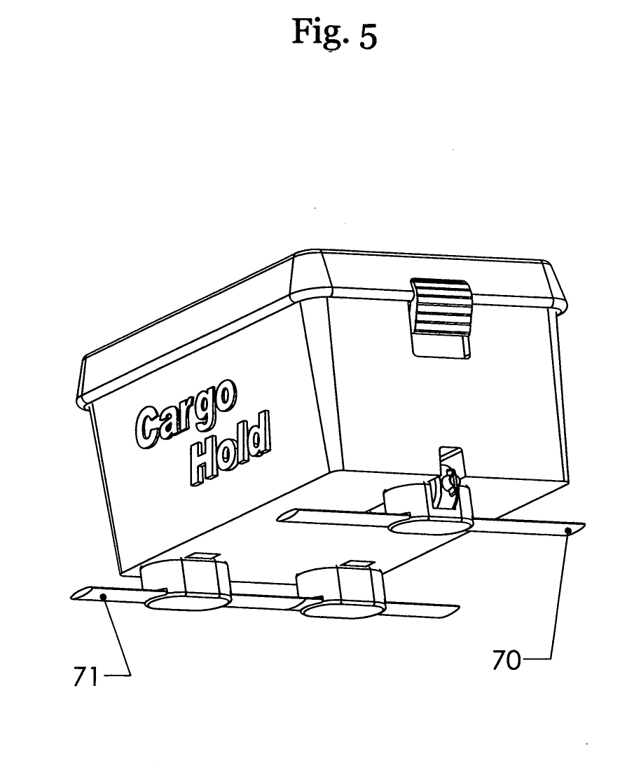

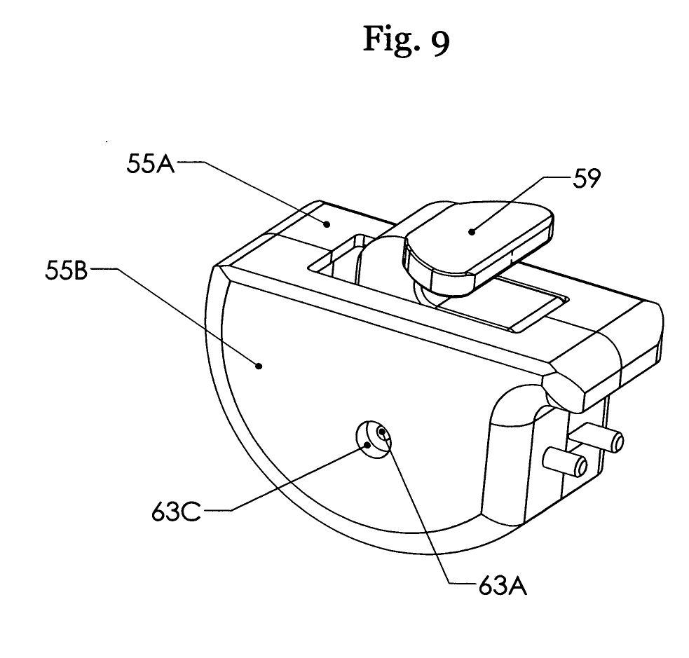

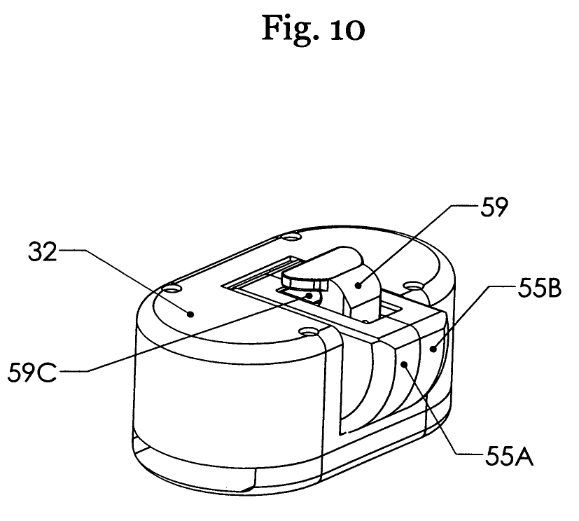

Companion rear static crossbar cradle clamp shown in FIG. 9, acts to align, cushion and retain rear retention rod(s) on a cargo vessel(s) loaded onto a vehicle roof rack in conjunction with said front mounted rotary latching unit. Base 32 (FIG. 10) positioned on rear crossbar is aligned with front latching unit in the case of luggage attachment (FIG. 12) or offset in pair's, equal distances from the centerline of a cargo vessel as shown in FIG. 5, with said static clamps mounted on rear crossbar 71 and a single corresponding said rotary clamping unit mounted on front crossbar 70.

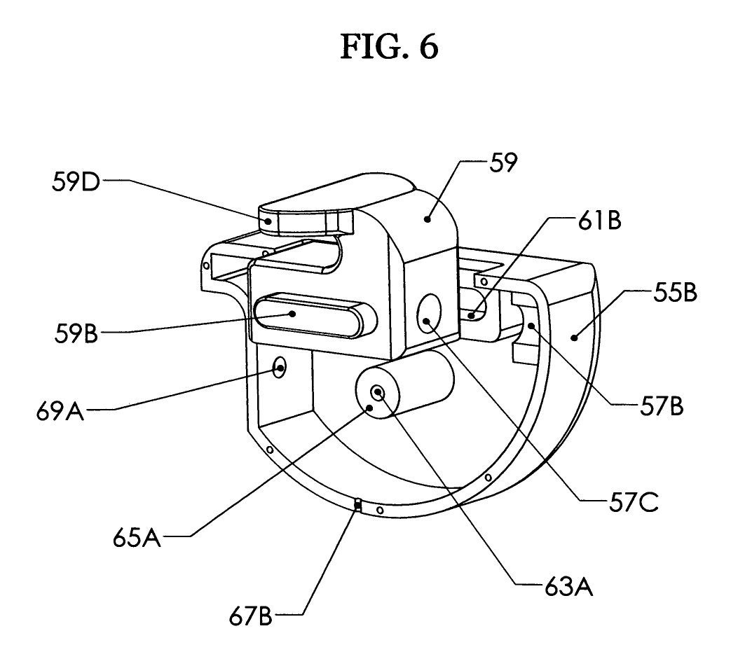

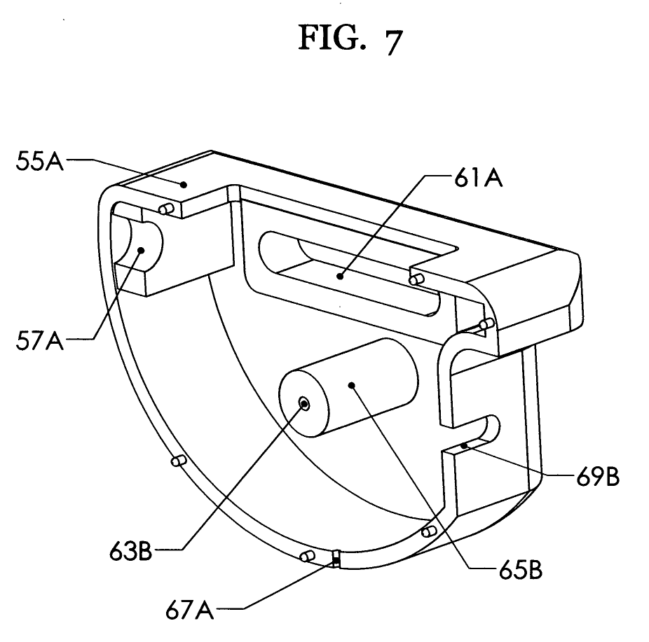

Referring to FIGS. 6 and 7, static shell half 55a houses a standard ⅜″ diameter stainless steel compression spring via spring recess 57a and blind hole recess 57c located on centerline of clamping block 59. Said spring provides sufficient pressure to hold said clamping block throat opening 59C securely against a cargo vessel or luggage rear retention rod effectively encasing said retention rod to prevent vertical carrier/luggage motion once engaged by spring loaded clamping block 59. In the preferred embodiment said spring is formed of stainless steel material to prevent rusting, and said spring is long enough and of sufficient wire size to provide at least five pounds of force against clamping block 59 at rest.

Static shell half 55a features slot guide 61a and matching slot guide 61b located in static shell half 55b (FIGS. 6 and 7) to guide clamping block 59 via boss projections on both sides of said clamping block as typified by boss 59b. Said clamping block 59 is restricted to linear movement parallel with slot guides when said static shell halves are assembled together, with said linear motion limited by the length of slots 61 a and 61b via the interface of said boss projections.

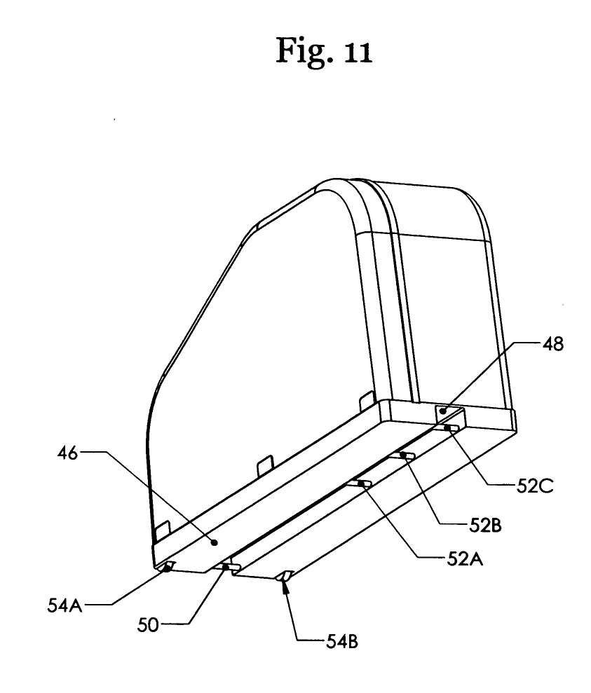

Referring to FIG. 4, alignment channels 44 and 42 containing rear retention rods 36a and 36b align on the centerline of clamping block 59 via enlarged projection 59d that acts to center the intended cargo vessel channel over clamping block 59. Simultaneously with the positioning of the channel horizontally, said rear retention rods are positioned at the correct vertical height to engage clamping block throat 59c (FIG. 10) via interface spacing created by said vessel bottom surface 38 resting on the cross bar cradle clamp base 32 when loading multi-channel cargo vessels, or in the case of luggage applications, rear retention rod 50 per FIG. 11. Located within static shell half 55a is assembly boss 65b containing centerline hole 63b that is sized to accept a stainless self-threading truss head screw. Static shell half 55b contains matching assembly boss 65a and through hole 63a that allows said truss head screw to pass through 63a without thread interference. Said truss head screw is flush relative to outside surface of 55b via counterbore 63c shown in FIG. 9 when tightened to hold said static shell halves together.

Static shell housing 55a features small alignment pins that are positioned around the outside mating surface that engage with corresponding holes in shell housing 55b to ensure correct alignment of the said housings when placed together, as commonly practiced in prior art molded plastic injection joints. Prior to the shell housing joining process stud 5a on clamping stud plate 26 is inserted into hole 69a inside of shell half 55b and as shell half 55a is aligned with 55b, stud 7a is guided into stud slot 69b in shell half 55a. Threaded studs 5a and 7a are used to align and permanently attach assembled static shell housings to base 32 using nuts and washers matching the thread requirements of said threaded studs.

On bottom periphery of static shell half 55a is half drain hole 67a that allows any water to pass through the device. Corresponding half drain hole 67b is found on static shell half 55b.

In the preferred embodiment, said static shell housings are formed using an ABS type plastic, however static shell housings can consist of any other formable material that can be molded with sufficient strength to withstand operational stresses that occur from repeated loading and unloading of heavy cargo vessel attachments by the user. The preferred embodiment material for clamping block 59 is wear resistant nylon type plastic, but any moldable material that can be molded with sufficient strength to withstand operational stresses that occur from repeated loading and unloading of heavy cargo vessel attachments by the user.

FIG. 11 details a luggage depiction of this invention that features accommodations for various standard separating distances between vehicular roof rack crossbars as shown with front retention rod 50 and rear retention rods spaced for short (52A), medium (52B), and long (52C), spacing relative to said front retention rod location. Alignment channel 48 is used to guide said front rotary latch and static rear clamping of luggage on vehicle and surface 46 serves as the reference base interface as in said vehicular cargo vessel arrangement already discussed. Once user has removed the luggage from the vehicle said luggage can be easily moved using transport wheels 54A and 54B along with an industry standard telescoping handle used ubiquitously on luggage.

FIG. 12 depicts a luggage carrier ready for transport while retained on vehicular crossbars utilizing said front rotary latching unit and said rear static clamping unit.

### PART NUMBERING GLOSSARY

| Item No. | Item |
|---|---|
| 3 | hole through 12 |
| 4 | hole through 12 |
| 5 | hole through 12 |
| 5a | stud on 26 |
| 7 | hole through 14 |
| 7a | stud on 26 |
| 9 | large flat sided hole through 12 |
| 10 | rotary latch |
| 12 | shell housing |
| 12a | bellcrank boss |
| 14 | shell housing |
| 16 | release lever |
| 16a | release lever hole |
| 18 | latch fork |
| 20 | release rod |
| 22 | bellcrank |
| 22a | bellcrank pressure plate |
| 24 | release knob plate |
| 24a | actuation dowel pin |
| 24b | release knob |
| 24c | release knob mounting body nut |
| 26 | threaded stud plate |
| 30 | clamp bar |
| 30a | typical clamp bar starting screw hole |
| | location |
| 32 | crossbar cradle clamp base |
| 34 | front retention rod |
| 36a | left side rear retention rod |
| 36b | right side rear retention rod |
| 38 | bottom surface of cargo container |
| 40 | front alignment channel |
| 42 | left side rear alignment channel |
| 44 | right side rear alignment channel |
| 46 | luggage carrier bottom surface |
| 48 | luggage alignment channel |
| 50 | front retention rod-luggage |
| 52a | luggage retention rod-crossbar |
| | positioned short |
| 52b | luggage retention rod-crossbar |
| | positioned medium |
| 52c | luggage retention rod-crossbar |
| | positioned long |
| 54a | left luggage transport wheel |
| 54b | right luggage transport wheel |
| 55a | static shell half-left |
| 55b | static shell half-right |
| 57a | spring recess cup-left |
| 57b | spring recess cup-right |
| 57c | spring recess hole |
| 59 | clamping block |
| 59b | left depiction of symmetrical |
| | clamping block boss projections |
| 59c | clamping block throat opening |
| 59d | clamping block guide projection |
| 61a | slot guide for static shell half-left |
| | side |
| 61b | slot guide for static shell half-right |
| | side |
| 63a | clearance hole for truss head screw |
| | in 55b and 65a |
| 63b | self-threaded screw starter hole |
| 63c | counterbore in 55b |
| 65a | assembly boss for 55b |
| 65b | assembly boss for 55a |
| 67a | left static shell half drain opening |
| 67b | right static shell half drain opening |
| 69a | threaded stud plate attachment hole |
| 69b | stud slot for 7a |
| 70 | front rooftop vehicle carrier crossbar |
| 71 | rear rooftop vehicle carrier crossbar |

We claim:

1. A roof-rack carrier system comprising:
a first roof rack bar;
a first rotary latch mounted on the first roof rack bar;
a cargo carrier vessel;
a first retention rod mounted adjacent a first end portion of the cargo carrier vessel; and,
the first rotary latch operable to lockingly engage the first retention rod thereby securing the cargo carrier vessel to the first roof rack bar.

2. A roof rack cargo carrier system as set forth in claim 1 further comprising:
a second roof rack bar;
a second rotary latch unit mounted on the second roof rack bar;
a second retention rod adjacent to a second end of the cargo carrier vessel; and,
a second rotary latch operable to locklingly engage the second retention rod thereby securing the cargo carrier vessel to the second roof rack bar.

3. A roof-rack cargo carrier system as set forth in claim 2 further comprising:
a third rotary latch unit mounted on the second roof rack bar;
a third retention rod adjacent to the second end of the cargo carrier vessel; and,
the third rotary latch operable to lockingly engage the third retention rod thereby securing the cargo carrier vessel to the second roof rack bar.

4. A roof-rack cargo carrier system as set forth in claim 1 wherein the first rotary latch is selected from the group consisting of remotely activated rotary latch, electronically-controlled rotary latch, pneumatically-actuated rotary latch, push button actuated rotary latch, or a lever arm activated rotary latch.

5. A roof-rack cargo carrier system as set forth in claim 1 further comprising:
a second roof rack bar;
at least one recess formed in the cargo carrier vessel and engageable with the second roof rack bar.

6. A roof-rack cargo carrier system as set forth in claim 1 wherein the rotary latch unit is selected from the group consisting of slam latches, compression latches, cam latches and paddle latches.

7. A roof-rack cargo carrier system as set forth in claim 1 wherein the first roof rack bar has a cross-sectional shape selected from the group consisting of round, oval, square, rectangular, diamond and sword shaped.

8. A roof-rack cargo carrier system as set forth in claim 1 wherein the rotary latch unit further comprises a latch fork selected to conform to a cross-sectional shape of the first roof rack bar.

9. A roof-rack cargo carrier system as set forth in claim 1 wherein the cargo carrier vessel exterior surface includes a recess and the first retention bar disposed in the recess.

10. A roof-rack cargo carrier system as set forth in claim 1 wherein the first rotary latch unit is integral with the first roof rack bar.

11. A roof-rack cargo carrier system as set forth in claim 1 further comprising a first mounting plate mounted on the cargo carrier vessel, and the first retention rod attached to the first mounting plate.

12. A roof-rack cargo carrier system as set forth in claim 1 wherein the first rotary latch is operable to disengage from the cargo carrier vessel with the cargo carrier vessel remaining unopened.

13. A roof-rack cargo carrier system as set forth in claim 1 wherein the cargo carrier vessel is selected from the group consisting of a suitcase, carry-on case, a cooler, a tool box, a document storage container, and a storage container.

14. A vehicle cargo carrier system comprising:
a first rotary latch unit mounted on a vehicle;
a cargo carrier vessel;
a first retention rod mounted adjacent to a first end portion of the cargo carrier vessel; and,
the first rotary latch operable to lockingly engage the first retention rod thereby securing the cargo carrier vessel to the vehicle.

15. A vehicle cargo carrier system as set forth in claim 14 further comprising a first recess in the vehicle and the first rotary latch mounted in the first recess.

16. A vehicle cargo carrier system as set forth in claim 14 further comprising the first retention rod operable from a first retracted position to a second extended position.

17. A roof-rack cargo carrier system as set forth in claim 1 further comprising the first retention rod operable from a first retracted position to a second extended position.

18. A roof-rack cargo carrier system as set forth in claim 1 wherein the first rotary latch includes at least one support surface engageable with the cargo carrier vessel.
